(19) United States
(12) Patent Application Publication
(10) Pub. No.: US 2026/0069020 A1
(43) Pub. Date: Mar. 12, 2026

(54) Augmented Reality Glasses for Enhanced Vision and Integration in Beauty Product Application

(71) Applicant: ELC MANAGEMENT LLC, Melville, NY (US)

(72) Inventor: Christopher Aidan, Austin, TX (US)

(73) Assignee: ELC MANAGEMENT LLC, Melville, NY (US)

(21) Appl. No.: 18/830,283

(22) Filed: Sep. 10, 2024

(51) Int. Cl. A45D 44/00; G02B 27/01; G06F 3/01; G06V 10/141; G06V 40/16

(52) U.S. Cl. CPC A45D 44/005; G02B 27/0101; G02B 27/017; G06F 3/011; G06V 10/141; G06V 40/171; A45D 2044/007; G02B 2027/0138; G02B 2027/0178

(57) ABSTRACT

An augmented reality (AR) eyewear device is provided. The AR eyewear device may include one or more AR interfaces configured to superimpose text or images upon an FOV of one or more transparent components associated with a user's eyes; sensors configured to capture real-time data associated with the user's face; processors; and non-transitory computer-readable memories storing instructions that, when executed by the one or more processors, cause the processors to: receive an indication of a makeup look selected by the user; analyze the real-time data associated with the user's face in order to generate a three-dimensional map associated with the user's face; identify facial features on the three-dimensional map; and provide, via the AR interfaces, guidance associated with applying one or more cosmetic products to the user's facial features in order to achieve the makeup look selected by the user.

### FIELD OF THE INVENTION

The present invention relates generally to the field of cosmetics and, more specifically, to an augmented reality (AR) eyewear device utilizing machine learning, artificial intelligence, augmented reality, and other technologies to assist in cosmetic product application.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Conventionally, applying makeup and/or skincare products often requires close attention to colors, details, and contrasts to achieve a desired look or a desired effect. However, many individuals have various vision limitations, which may result in difficulties in seeing the colors, details, and/or contrasts of makeup and/or skincare products, or difficulties in seeing the colors, details, and/or contrasts of their own facial features, and consequently may encounter difficulties in applying makeup and/or skincare products to achieve such desired looks or desired effects. That is, conventionally, the application of beauty and skincare products requires a level of precision and visual acuity that can be challenging for individuals with partial vision. Traditional methods and tools offer limited assistance, relying heavily on tactile feedback or the aid of others, which can compromise the independence and confidence of these individuals.

### SUMMARY

In one aspect, an augmented reality (AR) eyewear device is provided, comprising: an eyewear frame configured to be worn by a user, the eyewear frame having one or more transparent components associated with eyes of a user; one or more AR interfaces configured to superimpose one or more of text or images upon a field of view (FOV) of the one or more transparent components; one or more sensors configured to capture real-time data associated with a face of a user; and a controller, comprising: one or more processors; and one or more non-transitory memories storing computer-readable instructions. The computer-readable instructions, when executed by the one or more processors of the controller, may cause the one or more processors to: receive an indication of a makeup look selected by the user; analyze the real-time data associated with the face of the user in order to generate a three-dimensional map associated with the face of the user; identify one or more facial features of the face of the user on the three-dimensional map associated with the face of the user; and provide, via the one or more AR interfaces, guidance associated with applying one or more cosmetic products to the one or more facial features of the user in order to achieve the makeup look selected by the user. The AR eyewear device may include additional, less, or alternate elements, including those discussed elsewhere herein.

In another, a computer-implemented method for controlling an AR eyewear device via one or more processors is provided. The method may include receiving, by one or more processors, an indication of a makeup look selected by a user of the AR eyewear device; analyzing, by the one or more processors, real-time data associated with a face of the user captured by one or more sensors of the AR eyewear device in order to generate a three-dimensional map associated with the face of the user; identifying, by the one or more processors, one or more facial features of the face of the user on the three-dimensional map associated with the face of the user; and causing, by the one or more processors, one or more AR interfaces of the AR eyewear device to superimpose, upon a field of view (FOV) of one or more transparent components of the AR eyewear device associated with one or more eyes of the user, guidance associated with applying one or more cosmetic products to the one or more facial features of the user in order to achieve the makeup look selected by the user. The method may include additional, less, or alternate actions, including those discussed elsewhere herein.

In still another aspect, a non-transitory computer-readable storage medium storing instructions for controlling an AR eyewear device via one or more processors is provided. The computer-readable instructions, when executed by one or more processors, may cause the one or more processors to perform a method. The method may include receiving, by one or more processors, an indication of a makeup look selected by a user of the AR eyewear device; analyzing, by the one or more processors, real-time data associated with a face of the user captured by one or more sensors of the AR eyewear device in order to generate a three-dimensional map associated with the face of the user; identifying, by the one or more processors, one or more facial features of the face of the user on the three-dimensional map associated with the face of the user; and causing, by the one or more processors, one or more AR interfaces of the AR eyewear device to superimpose, upon a field of view (FOV) of one or more transparent components of the AR eyewear device associated with one or more eyes of the user, guidance associated with applying one or more cosmetic products to the one or more facial features of the user in order to achieve the makeup look selected by the user. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIGS. 1A and 1B depict exemplary augmented reality (AR) eyewear devices, according to some embodiments;

FIG. 1C depicts an exemplary computer system associated with controlling an AR eyewear device, according to some embodiments;

FIGS. 2A-2C depict examples of displays as may be provided by a user interface associated with an AR eyewear device, according to some embodiments; and FIG. 3 depicts a flow diagram of an exemplary computer-implemented method for controlling an AR eyewear device, according to some embodiments.

While the systems and methods disclosed herein are susceptible of being embodied in many different forms, they are shown in the drawings and are described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein are not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

The present disclosure relates to an innovative augmented reality (AR) glasses system (also called an “AR eyewear device”, and/or “AR eyewear system” herein) designed to assist individuals with partial vision or other vision limitations in the application of beauty and skincare products. Leveraging advanced image recognition technology, the AR eyewear device provided herein may enhance visual details, magnify content, and adjust contrast to aid in the accurate application of makeup. In some examples, the AR eyewear device may integrate with a comprehensive digital beauty ecosystem, encompassing haptic feedback devices, smart home systems, and mobile applications to provide a seamless, interactive beauty routine experience.

In some examples, the AR eyewear device may provide real-time image recognition capabilities that allow users to identify beauty products and receive auditory feedback detailing product names, colors, and usage instructions. In some examples, the AR eyewear device may be equipped with environmental sensors to adjust recommendations based on lighting conditions and UV exposure, ensuring optimal application in any setting. In some examples, the AR eyewear device may be configured to connect with wearable haptic devices, offering tactile guidance that enhances precision in makeup application, catering specifically to the needs of users with varying levels of visual impairment.

Furthermore, in some examples, the AR eyewear device may support customizable visual and auditory aids, ensuring accessibility and ease of use. Additionally, the AR eyewear device may be integrated with virtual assistants and social media platforms allows for a connected experience, enabling users to share tips, participate in virtual beauty sessions, and access a vast library of interactive tutorials and courses. In some examples, the AR eyewear device may not also promote skin health through features like stress detection, wellness recommendations, and personalized skincare regimens.

The AR eyewear device provided herein represents a significant advancement in the integration of AR technology within the beauty industry, offering a novel solution for individuals with partial vision to independently and accurately apply beauty products, thereby enhancing their confidence and autonomy in personal grooming tasks.

The present invention relates to augmented reality (AR) technologies, specifically to AR eyewear designed to assist individuals with partial vision in the application of beauty and skincare products. It integrates advancements in AR visualization, wearable computing, and interactive software applications to develop a comprehensive system aimed at assisting individuals with visual impairments. This invention stands at the intersection of assistive technology, cosmetic and skincare product application, and digital health and wellness management, embodying a multidisciplinary approach to enhancing the independence and lifestyle quality of users with partial vision through the innovative use of AR eyewear.

### Example AR Eyewear Device

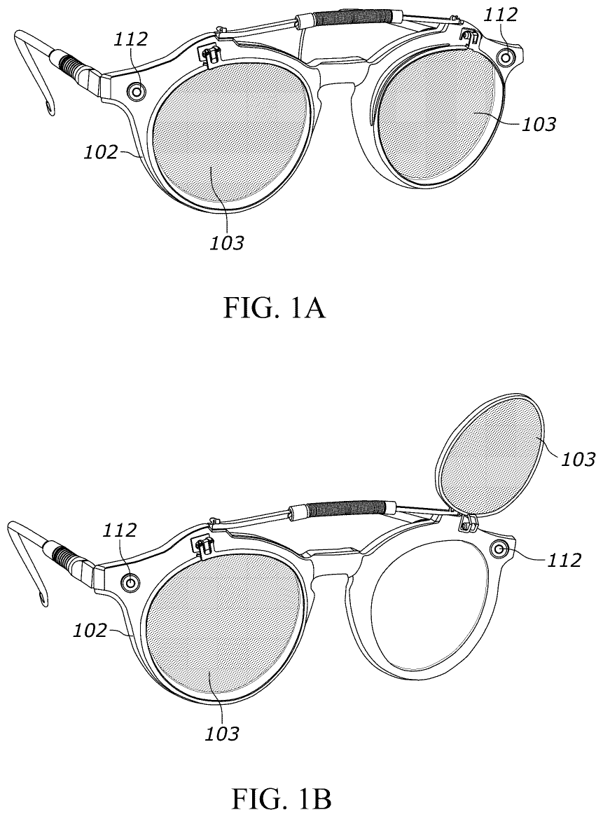

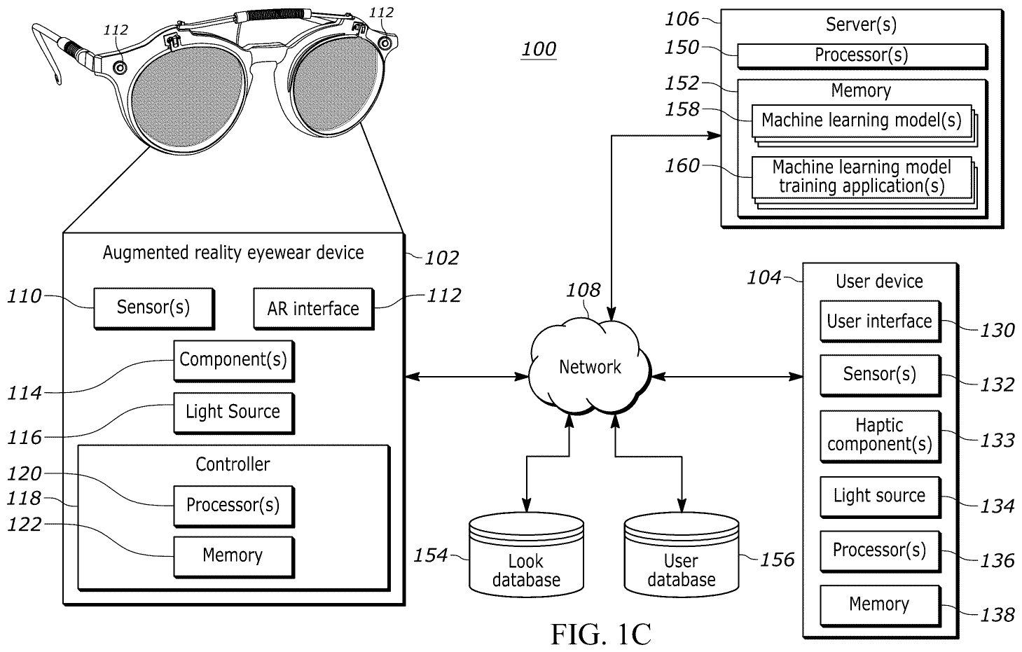

As shown in FIGS. 1A and 1B, an augmented reality (AR) eyewear device 102 may include a frame or other housing configured to be worn on a user's face, and one or more transparent components 103 associated with the user's eyes, as well as one or more AR components 112 configured to provide an AR overlay over the field of view (FOV) of the user's eyes through the transparent components 103. For instance, in some embodiments, the AR eyewear device may be a pair of eyeglasses, in which case the transparent components 103 may be lenses, which may or may not be magnified. Furthermore, in some embodiments, the AR eyewear device may be a pair of sunglasses, in which case the transparent components 103 may be shaded or tinted lenses, which may or may not be magnified.

Furthermore, the AR eyewear device 102 may include one or more sensors (as described in greater detail below with respect to FIG. 1C) configured to capture sensor data associated with the face of the user and/or the environment of the user. The one or more AR components 112 may be configured to provide AR guidance associated with applying cosmetic products to the face of the user based on the captured sensor data. For instance, the AR guidance may include text, images, videos, etc., visually superimposed upon the FOV of the transparent component(s) 103. For example, a user looking at his or her face in a mirror while wearing the AR eyewear device 102 may see the guidance that is visually superimposed upon the FOV of the transparent component(s) 103 as superimposed upon his or her face as it appears in the mirror.

As shown in FIG. 1B, in some examples, one or more of the transparent components 103 of the AR eyewear device 102 may be configured to be moved, manually or automatically, so that a user can access his or her eye area in order to apply one or more cosmetic products to the eye area without fully removing the AR eyewear device 102. For instance, in some examples, guidance related to applying a cosmetic product to a user's first eye (e.g., the user's left eye) may be superimposed upon a transparent component (e.g., the right transparent component) associated with the user's second eye (e.g., the user's right eye), while the transparent component (e.g., the left transparent component) associated with the user's first eye (e.g., the user's right eye) may be automatically or manually moved so that the user can apply the cosmetic product to the user's first eye (e.g., the user's left eye) in accordance with the provided guidance. In other examples, both transparent components may be automatically or manually moved when the user applies cosmetic products to his or her eyes, and the guidance associated with applying the cosmetic products to his or her eyes may be provided via another medium (e.g., via a smart mirror, a user device such as a smart phone or smart watch, etc.) or audibly/verbally rather than visually.

### Example System

FIG. 1C depicts an exemplary computer system 100 associated with an augmented reality (AR) eyewear device 102, according to some embodiments. The high-level architecture illustrated in FIG. 1C may include both hardware and software applications, as well as various data communications channels for communicating data between the various hardware and software components, as is described below.

The exemplary computer system 100 may include an AR eyewear device 102 (which may include, e.g., smart glasses, smart sunglasses, smart goggles, etc.) as well as, in some cases, one or more user computing devices 104 (which may include, e.g., smart phones, smart watches or fitness tracker devices, tablets, laptops, virtual reality headsets, wearables, etc.), and/or one or more server(s) 106. The AR eyewear device 102, user device(s) 104 and/or server(s) 106 may each include respective communication interfaces, and may be operable to communicate with one another via a wired or wireless computer network 108 and/or via short range signals, such as BLUETOOTH signals.

Although one AR eyewear device 102, one user device 104, one server 106, and one network 108 are shown in FIG. 1C, any number of such AR eyewear devices 102, user devices 104, servers 106, and networks 108 may be included in various embodiments. To facilitate such communications, the AR eyewear devices 102, user 104, and/or servers 106 may each respectively comprise a wireless transceiver to receive and transmit wireless communications.

The AR eyewear device 102 may include one or more integrated sensors 110, an integrated AR interface 112, one or more integrated components 114, and/or an integrated light source 116. Additionally, the AR eyewear device 102 may include a controller 118, including one or more processor(s) 120, as well as one or more computer memories 122.

Generally speaking, the sensors 110 may be operable to capture real-time data associated with the face of a user and/or the environment of the user before, during, and/or after a user applies a cosmetic product using the AR eyewear device 102. The sensors 110 may be oriented towards the user's face or away from the user's face in various examples. In some examples, the sensors 110 may include, for instance, a camera and/or a depth sensor operable to capture data associated with the user's face (e.g., directly and/or as reflected in a mirror), data associated with various cosmetic products to be applied to the user's face and/or their packaging, distances from various features of the user's face to various cosmetic products and/or applicators for the various cosmetic products, etc. Furthermore, in some examples, the sensors 110 may include light configured to detect visible light and/or ultraviolet (UV) light in the environment of the user during the application of a cosmetic product and/or during the user's day-to-day life wearing the AR eyewear device 102. Moreover, the sensors 110 may include sensors (e.g., the camera and/or the depth sensor, or additional or alternative sensors) operable to capture biometric data associated with the user, such as facial recognition data, fingerprint recognition data, iris recognition data, etc.

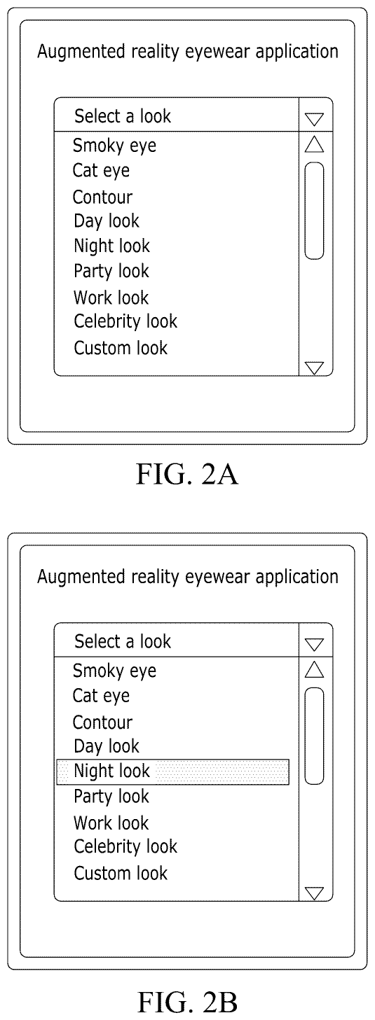

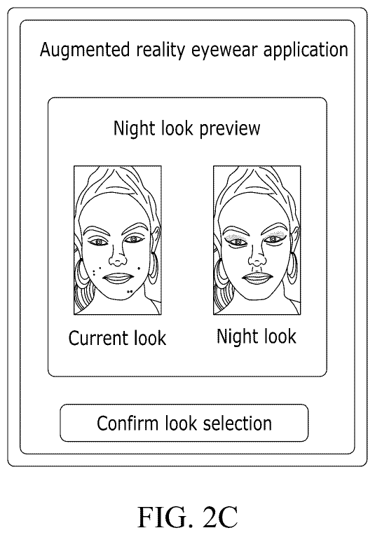

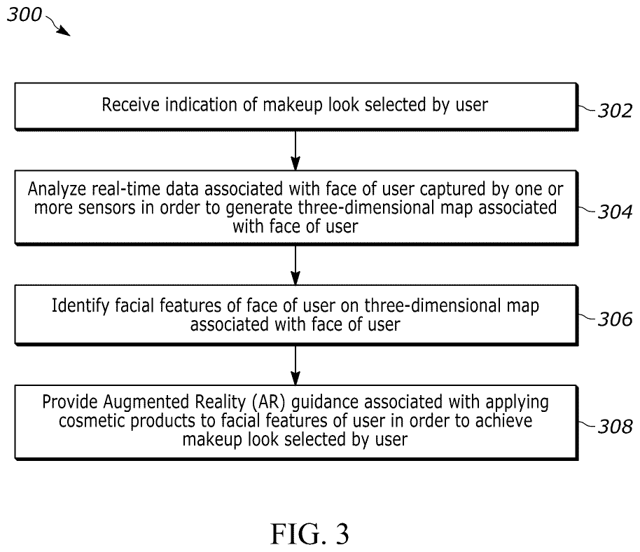

The AR interface 112 may include, for instance, a user interface component operable to receive inputs and selections from the user of the AR eyewear device 102, and/or to provide audible or visual feedback to the user of the AR eyewear device 102. For instance, the AR interface 112 may provide interactive displays via which users may select a desired makeup look to be applied to the user's face. The user may select a pre-existing look associated with pre-existing specifications for the AR eyewear device 102 to follow when applying the look, or may customize specifications for the AR eyewear device 102 to follow when applying the look. Additionally, the user may provide an image or a social media link which may be analyzed to determine the specifications for the AR eyewear device 102 to follow when applying the look. For instance, these specifications may include types of makeup applied to each area of the face, heaviness of makeup applied to each area of the face, particular patterns, shapes, or borders of makeup applied to each area of the face, layers of makeup applied to each area of the face, etc. Examples of such displays are shown at FIGS. 2A-2C below.

Moreover, the AR interface 112 may include one or more projectors configured to superimpose visual feedback (such as, e.g., text or images) upon a field of view (FOV) of the one or more transparent components 103, such that a user wearing the AR eyewear device sees the visual feedback through the transparent components 103. In some instances, the visual feedback may be generated so as to be superimposed upon the face of the user as it appears to the user wearing the AR eyewear device 102, i.e., as the user looks at his or her face reflected in a mirror while wearing the AR eyewear device 102. The visual feedback may include guidance associated with applying one or more cosmetic products to the face of the user to achieve a makeup look selected by the user. For instance, the guidance may include tracing lines or arrows associated with applying one or more cosmetic products to the one or more facial features of the user in order to achieve the selected makeup look. In some examples, the guidance provided by the AR interface 112 may further include audible feedback to accompany the visual feedback. For instance, the AR interface 112 may provide audio guidance related to the visual guidance associated with applying one or more cosmetic products to the face of the user to achieve a makeup look selected by the user.

Additionally, in some examples, the AR interface 112 may superimpose an enhanced (e.g., magnified, increased contrast, etc.) version of one or more features of the user's face upon the actual features of the user's face as they appear through the FOV of the one or more transparent components 103, such the user may view a magnified or higher-contrast version of a facial feature when applying a cosmetic product to that facial feature. These features may assist visually-impaired users in applying cosmetic products to various facial features.

Furthermore, the AR interface 112 may be operable to generate and display an AR rendering of three-dimensional map of the user's face, and/or a selected makeup look as applied to the user's face. For example, in some cases, the AR interface 112 may superimpose or overlay an AR rendering of a preview of the selected makeup look as it would appear applied to the user's face over the user's actual face as reflected in a mirror within the FOV of one or more of the transparent components 103, to demonstrate the appearance of the selected makeup look if applied to the user's face. Furthermore, in some cases, the AR interface 112 may superimpose or overlay an AR rendering of a preview of one or more steps associated with applying the selected makeup look to the user's face over the user's actual face as reflected in a mirror within the FOV of one or more of the transparent components 103. For instance, the preview of each step may include a rendering of the cosmetic products already applied to the user's face in that step, as well as images or videos illustrating how to apply any additional cosmetic products in that step. Once a user has completed a step (which may be determined, for instance, based on data captured by the sensors 110 and/or based on user input), the AR interface may superimpose or overlay an AR rendering of a subsequent step until all steps are complete. Moreover, in some examples, the AR interface 112 may be operable to receive feedback from a user associated with a selected makeup look after the selected makeup look is applied to the user's face. Furthermore, the AR interface 112 may provide additional alerts, notifications, communications, etc., as discussed elsewhere herein.

In some examples, the components 114 of the AR eyewear device 102 may include the transparent components 103 (such as, e.g., lenses) discussed with respect to FIGS. 1A and 1B, as well as actuators to control the transparent components. These actuators may be configured to control one or both of the transparent components to move from an original position positioned near the eyes of the user to a second position away from the eyes of the user (e.g., by flipping up, twisting up, etc.) in certain situations, such as when a step of applying a selected makeup look includes a step of applying a cosmetic product to one or both eyes.

Furthermore, these actuators may be configured to control the transparent components to move back to the original position from the second position.

The light source 116 may integrated into the AR eyewear device 102, and may be operable to provide light to the face of the user of the AR eyewear device 102. In some examples, one or more light sources 116 may be oriented toward the face of the user to provide light to the face of the user directly. Moreover, in some examples, one or more light sources 116 may be oriented away from the face of the user to provide light to the face of the user indirectly (e.g., to provide light to a mirror in which the user's face is reflected). The light source 116 may provide light to the face of the user in accordance with one or more lighting parameters which may be selected by the user or determined by the AR eyewear device 102 or another device shown in FIG. 1C. For instance, in some examples, the determined lighting parameters may include a level, warmth, and/or direction of light to be provided based on a selection of lighting parameters made by the user (e.g., via the AR interface 112), based on a makeup look selected by the user, based on a particular cosmetic product being used by the user, based on a particular step within the process of the selected makeup look, and/or based on ambient lighting conditions in an area where the AR eyewear device 102 is being used.

The memories 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memories 122 may store an operating system (OS) (e.g., iOS, Microsoft Windows, Linux, UNIX, etc.) capable of facilitating the functionalities, apps, methods, or other software as discussed herein.

Generally speaking, the memories 122 may store instructions that, when executed by the processor(s), cause the processors 120 to receive an indication of a makeup look selected by the user (e.g., as user input via the AR interface 112, or from another device such as the user device 104). The instructions stored on the memories 122, when executed by the processor(s) 120, may cause the processor(s) 120 to analyze real-time data associated with the face of the user captured by the sensors 110 in order to generate a three-dimensional map associated with the face of the user, and identify one or more facial features of the face of the user on the three-dimensional map associated with the face of the user. Furthermore, the instructions stored on the memories 122, when executed by the processor(s) 120, may cause the processor(s) 120 to provide (e.g., via the AR interface 112) AR guidance associated with applying one or more cosmetic products to the one or more facial features of the user in order to achieve the makeup look selected by the user.

In particular, the instructions stored on the memories 122 may cause the processors 120 to analyze real-time sensor data captured by the sensors 110 (and/or external sensors, such as the sensors 132 of a user device 104) in order to generate a three-dimensional map associated with the user's face and identify the locations of one or more facial features (e.g., eyes, eyelids, eyebrows, eyelashes, cheeks, cheekbones, nose, lips, chin, etc.) of the user's face”) on the three-dimensional map. The instructions stored on the memories 122 may cause the processors 120 to analyze real-time sensor data captured by the sensors 110 (and/or external sensors, such as sensors 132 of a user device 104) in order to determine the location of an applicator and/or cosmetic product held by the user with respect to the facial features of the user's face (e.g., the location of a lipstick applicator or mascara wand held by the user with respect to the user's lips or eyes) and may cause the AR interface 112 to update the visual feedback/guidance based on the determined location of the applicator and/or cosmetic product.

For instance, when a user holds a lipstick applicator close to or touching the lips of the user's face, the instructions stored on the memories 122 may cause the AR interface 112 to provide guidance for the user to adjust the pressure of the lipstick applicator in real-time as the user moves the lipstick applicator across the user's lips, in order to apply lipstick in accordance with a selected makeup look that includes lipstick, in some cases including lipstick within the edges of the lips for some lipstick looks, or in some cases extending outside of the edges of the lips for an over-lined lipstick look. As another example, when a user holds a mascara wand applicator close to or touching the eyelashes of the user's face, the instructions stored on the memories 122 may cause the AR interface 112 to provide guidance to the user to slowly spin or stroke in a vertical direction in real-time as the user moves mascara wand applicator over the user's eyelashes, in order to apply mascara in accordance with a selected makeup look that includes mascara, in some cases including multiple coats of mascara for a selected makeup look including heavier mascara. As still another example, when a user holds an eyeliner applicator close to or touching the edge of the eyelid of the user's face, the instructions stored on the memories 222 may cause the AR interface 112 to provide guidance to the user to adjust the eyeliner applicator head vertically or laterally in real-time as the user moves the eyeliner applicator over the user's eyelid, in order to apply eyeliner in accordance with a selected makeup look that includes eyeliner (e.g., in a straight line with a pointed tip extending from the eye for a winged or cat-eye look, in a smudged line near the eyelid for a smoky-eye look, etc.).

Moreover, the instructions stored on the memories 122 may cause the AR interface 112 to modify or adjust the guidance based on conditions associated with the user's skin as detected in real-time, e.g., based on data captured by the sensors 110 or the sensors 132. For instance, the instructions stored on the memories 122 may cause the processor(s) 120 to analyze image data captured by the sensors 110 or the sensors 132 to detect blemishes of the user's skin, and may, for instance, cause the AR interface 112 to modify or adjust the guidance, such that additional cosmetic products or additional coats of cosmetic products, special cosmetic products specifically designed for blemishes, are applied to the affected area.

Furthermore, in some examples, the instructions stored on the memories 122 may cause the processor(s) 120 to analyze image data captured by the sensors 110 or the sensors 132 to detect skin health conditions, injuries, reactions, etc., of the user's skin, and may, in some cases, cause the AR interface 112 to adjust or modify the guidance to avoid further irritating or injuring any detected skin health conditions, injuries, reactions etc. Furthermore, in some examples, the instructions stored on the memories 122 may cause the processor(s) 120 to generate an alert based on the detected skin health condition, injury, reaction, etc., and provide the alert, e.g., via the AR interface 112 or send the alert to the user device 104 to be provided via the user interface 130 of the user device 104.

Furthermore, the instructions stored on the memories 122 may cause the AR interface 112 to modify or adjust the guidance based on conditions associated with the user's environment as detected in real-time as the user applies a cosmetic product, and/or over a period of time prior to the application of the cosmetic product, e.g., based on data captured by the sensors 110 or the sensors 132.

Furthermore, the memories 122 may store instructions that, when executed by the processor(s) 120, cause the processor(s) 120 to analyze images associated with cosmetic products to identify particular cosmetic products or characteristics thereof. For instance, the memories 122 may store instructions that, when executed by the processor(s) 120, cause the processor(s) 120 to capture image data (e.g., via the sensors 110) associated with packaging of various cosmetic products, and analyze the image data associated with the packaging of the various cosmetic products to identify respective cosmetic products based on their packaging. In some examples, for instance, the images may represent the FOV of the user wearing the AR eyewear device 102 through the one or more transparent components 103, such that when a user wearing the AR device 102 views a cosmetic product, images of the product are captured by the sensors 110 and analyzed by the processor(s) 120.

For instance, in some examples, this analysis may include using object recognition techniques to identify a likely type of cosmetic product and/or likely properties associated with the cosmetic product based on the image. Moreover, in some examples, this analysis may include analyzing an image of the cosmetic product packaging using optical character recognition techniques to identify one or more letters, numbers, words, codes, etc., on the cosmetic product packaging, and accessing a database associated with cosmetic products to match any identified letters, numbers, words, codes, etc., on the cosmetic product packaging with particular cosmetic products and/or particular properties associated therewith. As another example, this analysis may include analyzing an image of the cosmetic product packaging to identify and/or decode a barcode, QR code, etc. For instance, the payload of the barcode, QR code, etc., may include an identification or indication of the cosmetic product and/or properties associated therewith. In some examples, the memories 122 may store instructions that, when executed by the processor(s) 120, cause the processor(s) 120 to provide visual feedback (e.g., via the AR component 112) indicating the names and/or characteristics of any identified cosmetic products, or any usage instructions associated therewith. For instance, the visual feedback may be superimposed upon any identified products within the FOV of the one or more transparent components 103. Furthermore, the visual feedback may be magnified so that users with various vision impairments can read the names, characteristics, and/or usage instructions associate with any identified cosmetic products.

For instance, the instructions stored on the memories 122 may cause the processor(s) 120 to analyze lighting data captured by the sensors 110 or the sensors 132 to detect a lighting condition in the user's environment in real-time as the user applies the cosmetic product, e.g., indicating bright or dim lighting in the user's environment. For example, the instructions stored on the memories 122 may cause the processor(s) 120 to cause the AR interface 112 to modify or adjust the guidance, such that the guidance is visible to the user based on the lighting conditions. As another example, the instructions stored on the memories 122 may cause the processor(s) 120 to cause the AR interface 112 to modify or adjust the guidance such that cosmetic products appropriate for the lighting conditions are applied to the user's facial features.

Additionally, in some examples, the instructions stored on the memories 122 may cause the processor(s) 120 to analyze lighting data captured by the sensors 110 or the sensors 132 to detect a lighting condition in the user's environment over a period of time prior to the application of the cosmetic product, e.g., indicating a level of UV exposure the AR eyewear device 102 (and, by proxy, the user) typically experiences day-to-day. For example, the instructions stored on the memories 122 may cause the processor(s) 120 to cause the AR interface 112 to modify or adjust the guidance, such that the guidance includes guidance to apply products appropriate for the level of UV exposure the user typically experiences day-to-day. For instance, the instructions stored on the memories 122 may cause the processor(s) 120 to cause the AR interface 112 to provide guidance for applying a sunscreen product (and/or for applying a particular level of SPF protection) based on a high level of UV exposure experienced by the user day-to-day.

Furthermore, in some examples, the instructions stored on the memories 122 may cause the processor(s) 120 and/or the controller 118 to perform any or all of the steps of the method 300 discussed below with respect to FIG. 3.

The user device 104 may include, or may be operable to communicate with, a user interface 130, which may receive input from users and may provide audible or visible output to users, one or more sensors 132, one or more haptic components 133, and/or one or more light sources 134. Moreover, the user device 104 may include one or more processors 136, as well as one or more memories 138.

In some examples, the user interface 130 may include similar functionality as discussed above with respect to the AR interrace 112 of the AR eyewear device 102. Furthermore, the user device 104 may include, or may be operable to communicate with, one or more respective sensors 132, which may include similar sensors and/or sensor functionality as discussed above with respect to the sensors 110 of the AR eyewear device 102. The one or more haptic components 133 may be configured to provide haptic feedback (such as vibrations at various intensity levels, patterns, frequencies, etc.) to the user of the AR eyewear device 102 in real-time as the user applies or attempts to apply a cosmetic product, in some cases in conjunction with the AR guidance provided by the AR interface 112 of the AR eyewear device 102. Additionally, the user device 104 may include, or may be operable to communicate with one or more light sources 134 operable to provide light to the face of the user of the AR eyewear device 102, which may include similar functionality as discussed above with respect to the light source 116 of the AR eyewear device 102.

The memories 138 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memories 138 may store an operating system (OS) (e.g., iOS, Microsoft Windows, Linux, UNIX, etc.) capable of facilitating the functionalities, apps, methods, or other software as discussed herein.

The memories 138 may store instructions that, when executed by the processors 136 cause the processors 136 to receive input from a user as provided via the user interface 130 (e.g., via interactive user interface display screens discussed below with respect to FIGS. 2A-2C), and send the received user input to the AR eyewear device 102 (e.g., via the network 108, in some cases responsive to a request for such user input from the AR eyewear device 102. Furthermore, in some examples, the memories 138 may store instructions that, when executed by the processors 136, cause the processors 136 to capture sensor data via one or more sensors 132, in some cases responsive to a request for particular sensor data from the AR eyewear device 102, and may send the captured sensor data to the AR eyewear device 102.

Furthermore, memories 138 may store instructions that, when executed by the processors 136, cause the haptic component(s) 133 to provide haptic feedback to the user in real-time as the user wearing the AR eyewear device 102 as the user holds a cosmetic product or cosmetic product applicator to the user's face, to cause the user to hold or move the cosmetic product or cosmetic product applicator in accordance with a selected makeup look. For instance, the instructions stored on the memories 138 may cause the processors 136 to control the haptic component 133 to provide one type of haptic feedback (or to not provide haptic feedback) when the user's placement or movement of the cosmetic product or cosmetic product applicator is in accordance with the guidance provided by the AR interface 112 of the AR eyewear device 102 and to provide another type of haptic feedback (or to provide haptic feedback) when the user's placement or movement of the cosmetic product or cosmetic product applicator is not in accordance with the guidance provided by the AR interface 112 of the AR eyewear device 102. As another example, the instructions stored on the memories 138 may cause the processors 136 to control a haptic component 133 located on one side or portion of the user device 104 to provide haptic feedback to indicate that the user should start (or stop) moving the cosmetic product or cosmetic product applicator in that direction, in accordance with the guidance provided by the AR interface 112 of the AR eyewear device 102 for applying the selected makeup look.

For instance, the instructions stored on the memories 138 may cause the processors 136 to control a haptic feedback component 133 to provide one type of haptic feedback (and/or the absence of haptic feedback) when the sensors 110 or sensors 132 detect that the user is using an eyeliner applicator pencil to draw a straight line across a user's eyelid for a cat eye look, and another type of haptic feedback (and/or the presence of haptic feedback) when the sensors 110 or sensors 132 detect that the user is using the eyeliner applicator pencil to draw a crooked line or otherwise veer from an initial straight line across the user's eyelid.

As another example, the instructions stored on the memories 138 may cause the processors 136 to control a haptic feedback component 133 to provide a first type of haptic feedback when the user holds a mascara wand applicator too close to the eye to apply mascara, a second type of haptic feedback (or the same type of haptic feedback as the first type of haptic feedback) when the user holds the mascara wand applicator too far from the eye to apply mascara, and a third type of haptic feedback (or the absence of haptic feedback) when the user holds the mascara wand applicator a correct distance from the eye to apply mascara (i.e., in accordance with the guidance provided by the AR interface 112 of the AR eyewear device 102 for applying the selected makeup look).

For instance, if the user device 104 is a smart watch, the instructions stored on the memories 138 may cause the processors 136 to control a haptic feedback component 133 to provide different vibrations, vibrational intensity, vibrational patterns, etc., to the user's wrist based on comparing the user's movements as detected by the sensors 110 or sensors 132 to the guidance provided by the AR interface 112 of the AR eyewear device 102 for applying the selected makeup look.

Moreover, in some examples, the memories 138 may store instructions that, when executed by the processors 136, cause the processors 136 to provide light to the face of the user via a light source 134, in some cases responsive to a request from the AR eyewear device 102, to provide light to the face of the user. In some examples, the request may include a request for a particular lighting parameters, such as a particular level/intensity of light, or a particular warmth or color of light, and the processors 136 may in turn cause the light source 134 to provide the requested level/intensity, color, warmth, etc. of light to the face of the user.

Furthermore, in some examples, the instructions stored on the memories 138 may cause the processors 136 to perform any or all of the steps of the method 300 discussed below with respect to FIG. 3.

In some embodiments the 106 may comprise one or more servers, which may comprise multiple, redundant, or replicated servers as part of a server farm. In still further aspects, such server(s) 106 may be implemented as cloud-based servers, such as a cloud-based computing platform. For example, such server(s) 106 may be any one or more cloud-based platform(s) such as MICROSOFT AZURE, AMAZON AWS, or the like. Such server(s) 106 may include one or more processors 150 (e.g., CPUs) as well as one or more computer memories 152.

The memories 152 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memories 152 may store an operating system (OS) (e.g., Microsoft Windows, Linux, UNIX, etc.) capable of facilitating the functionalities, apps, methods, or other software as discussed herein. The memories 152 may store one or more machine learning models 158, and/or one or more respective machine learning model training applications 160. These machine learning models 158 may include, for instance, a machine learning model trained to analyze data associated with a user's face and/or a three-dimensional map associated with the user's face to identify facial features thereon, a machine learning model trained to analyze images associated with makeup looks to identify cosmetic products and/or techniques used to create the makeup looks, a machine learning model trained to analyze data associated with the user's skin to identify a skin type or a skin health condition associated with the user, a machine learning model trained to analyze data associated with previous makeup looks selected by a user to predict additional makeup looks for the user, etc.

Additionally, or alternatively, the memories 152 may store makeup look data, and/or user data. The makeup look data may include, for instance, specifications associated providing guidance for applying the various makeup looks to various facial structures, and may also be stored in database 154 (or in multiple such databases), which may be accessible or otherwise communicatively coupled to the server 106. The user data may include previous makeup looks worn by the user, user preferences, and various other data associated with the user, and may also be stored in a user database 156 (or in multiple such databases), which may be accessible or otherwise communicatively coupled to the server 106. Furthermore, in some examples, the makeup look data and the user data may be stored in the same database, which may be accessible or otherwise communicatively coupled to the server 106.

Furthermore, the memories 152 may store instructions that, when executed by the processors 150, cause the processors 150 to receive data from various databases such as databases 154 and/or 156, and/or data from the AR eyewear device 102 and/or the user device 104 (e.g., via the network 108). The data from the AR eyewear device 102 and/or the user device 104 may include, for instance, data captured by the sensors 110 of the AR eyewear device 102 and/or data captured by the sensors 132 of the user device 104, data input by a user via a user interface component of the AR eyewear device (e.g., via a component 114 and/or via the AR interface 112) and/or data input by a user via the user interface 130 of the user device 104, etc. The instructions stored on the memories 152, when executed by the processors 150, may cause the processors 150 to analyze data received from the database, and/or the AR eyewear device 102 and/or the user 104 in order to make an identification or a prediction based on the received data, and subsequently send the identification and/or prediction to the AR eyewear device 102 and/or the user device 104. For instance, this analysis and identification and/or prediction may be based upon applying a trained machine learning model 158 to the data received from the databases and/or the AR eyewear device 102 and/or the user device 104.

In some examples, one or more machine learning model(s) 158 may be executed on the server 106, while in other examples one or more machine learning model(s) 158 may be executed on another computing system, separate from the server 106. For instance, the server 106 may send data to another computing system, where a trained machine learning model 158 is applied to the data, and the other computing system may send a prediction or identification, based upon applying the trained machine learning model 158 to the data, to the server 106. Moreover, in some examples, one or more machine learning model 158(s) may be trained by respective machine learning model training application(s) 160 executing on the 106, while in other examples, one or more machine learning model(s) 158 may be trained by respective machine learning model training application(s) executing on another computing system, separate from the server 106.

Whether the machine learning model(s) 158 are trained on the server 106 or elsewhere, the machine learning model(s) 158 may be trained by respective machine learning model training application(s) 160 using training data (including historical data in some cases), and the trained machine learning model(s) 158 may then be applied to new/current data that is separate from the training data in order to determine, e.g., predictions and/or identifications related to the new/current data.

For example, a machine learning model 158 trained to analyze data associated with a user's face and/or a three-dimensional map associated with the user's face to identify facial features thereon may be trained by a machine learning model training application 160 using training data including images of various faces and/or three-dimensional maps associated with the various faces, and indications of locations of facial features in the images and/or three-dimensional maps. For instance, each image and/or three-dimensional map may be labeled to indicate locations of facial features such as the eyes, eyelids, eyebrows, eyelashes, cheeks, cheekbones, nose, lips, chin, etc. on the face, and these labeled images and/or three-dimensional maps may be used as training data. Once sufficiently trained using this training data, such a machine learning model 158 may be applied to a new image, video, and/or three-dimensional map associated with a user's face (e.g., an image or video captured by the sensors 110, 132, etc., in real-time), and may identify likely locations of various facial features of the user's face.

As another example, a machine learning model 158 trained to analyze images associated with makeup looks to identify cosmetic products and/or techniques used to create the makeup looks may be trained by a machine learning model training application 160 using training data including images of individuals with various makeup looks applied, and indications of cosmetic products and/or techniques that were used to create the looks shown in the images. For instance, an image of an individual wearing a particular makeup look may be labeled with a particular color or brand of mascara, blush, lipstick, foundation, etc., used to create the look, as well as types of applicators used to create the look, number of coats/layers of each cosmetic product, techniques such as motions, patterns, shapes, or lines used to create the look, etc., and these labeled images may be used as training data. Once sufficiently trained using this training data, such a machine learning model 158 may be applied to a new image, such as an image provided by a user via a user interface 130, or an image from a social media link provided by the user via the user interface 230, and may identify/predict cosmetic products and/or techniques that may be used to replicate the makeup look shown in the image. In some examples, the machine learning model 158 may further generate specifications to be used by the AR eyewear device 102 when providing guidance for replicating the makeup look shown in the image.

Moreover, as another example, a machine learning model 158 trained to analyze data associated with the user's skin to identify a skin type or a skin health condition associated with the user may be trained by a machine learning model training application 160 using training data including images or other sensor data associated with various individuals'skin, and indications of skin types, skin health conditions, or other skin characteristics associated with the various individuals'skin. For instance, images of individuals having various skin types may be labeled with the respective skin types shown in each image. Similarly, images of individuals having various skin health conditions may be labeled with an indication of the health condition, the location of visual indicators associated with the health condition shown in the image, etc.

Furthermore, images of individuals having various skin characteristics may be labeled with the respective skin characteristics. These labeled images may be used as training data, and once sufficiently trained using this training data, such a machine learning model 158 may be applied to a new image, video, and/or three-dimensional map associated with a user's face (e.g., an image or video captured by the sensors 110, 132, etc., in real-time), and may identify/predict a skin type, skin health condition, and/or other skin characteristic associated with the user's face.

Additionally, as another example, a machine learning model 158 trained to analyze data associated with previous makeup looks selected by a user to predict additional makeup looks for the user may be trained by a machine learning application 160 using training data including makeup looks selected by previous users, characteristics of the previous users, input/feedback from the previous users about the makeup looks, once applied using guidance provided by an AR eyewear device 102, etc. For instance, various makeup looks may be labeled with indications of characteristics of users who gave positive feedback regarding the makeup looks, indications of other looks receiving positive feedback from the same users, etc. Once sufficiently trained using this training data, such a machine learning model 158 may be applied to a user, the user's characteristics, and previous makeup looks selected/liked by the user, and may predict/suggest other makeup looks that the user may enjoy.

In various aspects, the machine learning model(s) 158 may comprise machine learning programs or algorithms that may be trained by and/or employ neural networks, which may include deep learning neural networks, or combined learning modules or programs that learn in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the machine learning model(s) 158 may comprise a library or package executed on the server 106 (or other computing devices not shown in FIG. 1C). For example, such libraries may include the TENSORFLOW based library, the PYTORCH library, and/or the SCIKIT-LEARN Python library.

Machine learning may involve identifying and recognizing patterns in existing data (such as training a model based upon historical data) in order to facilitate making predictions or identification for subsequent data (such as using the machine learning model on new/current data order to determine a prediction or identification related to the new/current data).

Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

In addition, memories 152 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memory 152 may include instructions for carrying out any of the steps of the method 300 via an algorithm executing on the processors 150, which is described in greater detail below with respect to FIG. 3. It should be appreciated that one or more other applications may be envisioned and that are executed by the processor(s) 150. It should be appreciated that given the state of advancements of mobile computing devices, any or all of the processes functions and steps described herein may be present together on a mobile computing device, such as the user device 104, or the AR eyewear device 102.

### Example User Interface Displays

FIGS. 2A-2C depict exemplary user interface displays as may be provided by a user interface of the augmented reality (AR) eyewear device 102 (e.g., an AR interface 112 or other component 114 of the AR eyewear device 102) and/or of an associated user device (e.g., user device 104). For instance, FIG. 2A illustrates an example user interface display via which a user may select a makeup look, and FIG. 2B illustrates an example user interface display via which a user has already selected a makeup look. For instance, the user may select between pre-set options such as “smoky eye,” “cat eye,” “contour,” “day look,” “night look,” “party look,” “work look,” “celebrity look,” etc. In some examples, the pre-set options may differ based on, for instance, whether a user is subscribed to a makeup look subscription service, or whether the user is operating the AR eyewear device 102 in a “professional” mode compared to an “amateur” mode. Some of these options may include still-further options (not shown)—for instance, a user may select a specific celebrity for a “celebrity look,” or may select options for each facial feature to create a custom look. These options may include, for instance, types of products applied, how heavily each of the products are applied to each facial area, etc. Furthermore, in some examples, the user may be prompted to upload an image of a desired look, or a link to a social media post including a desired look, which may be analyzed to generate specifications associated with providing guidance for applying the desired look, for use by the AR eyewear device 102.

FIG. 2C illustrates an example preview of the look selected by the user at FIG. 2B. In some examples, the preview may be a generalized preview, e.g., illustrating examples of other individuals to whom the look has been applied, or illustrating examples of a three-dimensional rendering of the look as applied to a three-dimensional model of a face. As shown in FIG. 2C, the preview includes a rendering of the user's current look and a rendering of a predicted look including the selected makeup look. Furthermore, as shown in FIG. 2C, the preview includes an option to confirm the selected look. Upon confirming the selected look, the specifications associated with providing guidance for applying the desired look may be sent to the AR eyewear device 102.

### Example Method

FIG. 3 depicts a flow diagram of an exemplary computer-implemented method 300 for controlling an AR eyewear device (e.g., the AR eyewear device 102), according to one embodiment. One or more steps of the method 300 may be implemented as a set of instructions stored on a computer-readable memory (e.g., memory 122, memory 138, memory 152, etc.) and executable on one or more processors (e.g., processor 120, processor 136, processor 150, etc.).

The method 300 may include receiving (block 302), from a user interface associated with the AR eyewear device, an indication of a makeup look selected by the user. In some examples, the user interface may be integrated into the AR eyewear device (e.g., the AR interface 112 of the AR eyewear device 102), while in other examples, the user interface may be part of a separate device, such as a user device (e.g., the user interface 130 of the user device 104), and/or another separate device. In embodiments in which the user interface is part of a separate device, receiving the indication of the makeup look selected by the user may include the AR eyewear device receiving the indication of the makeup look selected by the user at a communication interface of the AR eyewear device, e.g., via a network (e.g., the network 108), via a short range signal between the separate device and the AR eyewear device, and/or via a wired connection between the separate device and the AR eyewear device.

For instance, the user interface may provide a listing of possible makeup looks from which the user may select a makeup look. In some examples, the listing of possible makeup looks may include an indication of which makeup looks have previously been selected by the user. Moreover, in some examples, the listing of possible makeup looks may be modified (to include more looks, fewer looks, or otherwise different looks) based on whether the user is subscribed to a makeup look subscription service. Additionally, in some examples, the listing of possible makeup looks may include an indication of one or more suggested makeup looks for the user. For example, the method 300 may include providing suggested makeup looks for the user based on previous looks selected by the user, based on current trends associated with one or more makeup looks, based on a mood of the user, based on preferences indicated by the user, based on an indication, from the user, of an event or setting at which the user will be wearing the makeup look, based on a time of day or year, etc.

In some examples, providing suggested makeup looks for the user based on previous looks selected by the user may include applying a trained machine learning model to previously selected looks in order to identify a suggested look for the user. For instance, the method 300 may include training a machine learning model using historical data associated with makeup looks selected by other users, and feedback associated therewith. Once trained, the machine learning model may be capable of predicting a makeup look for a user based on previous makeup looks selected by the user.

In some examples, prior to proceeding to the further steps of the method 300, the method 300 may include analyzing biometric data associated with the user (e.g., as captured by one or more integrated sensors 110 of the AR eyewear device 102, or sensors of a separate device, such as the sensors 132 of the user device 104) in order to determine whether the user is an authorized user of the AR eyewear device. If the user is an authorized user of the AR eyewear device, the method 300 may proceed, but if the user is not an authorized user of the AR eyewear device, the method 300 may not proceed further, i.e., such that the operation of the AR eyewear device is restricted to only authorized users.

Furthermore, the method 300 may include analyzing (block 304) real-time data associated with the face of the user captured by one or more sensors in order to generate a three-dimensional map associated with the face of the user. For instance, the sensors may include integrated sensors of the AR eyewear device (e.g., sensors 110 of the AR eyewear device 102), and/or sensors of a separate device, such as a user device (e.g., sensors 132 of the user device 104), and/or another separate device. The sensors may include, for instance, cameras or depth sensors, or other suitable sensors. In some examples, the sensors may capture the real-time data associated with the face of the user as reflected in a mirror as the user wears the AR eyewear device.

In embodiments in which the sensors include sensors that are part of a separate device, the AR eyewear device may request sensor data from, and/or receive sensor data captured by, the sensors of the separate device via a communication interface of the AR eyewear device, e.g., via a network (e.g., network 108), via a short range signal between the separate device and the AR eyewear device, and/or via a wired connection between the separate device and the AR eyewear device. For instance, the separate devices could include a smart mirror device (e.g., as discussed in U.S. patent application Ser. No. 18/444,382, which is incorporated by reference herein), a smart makeup compact device (e.g., as discussed in U.S. patent application Ser. No. 18/444,343, which is incorporated by reference herein), a smart makeup applicator device (e.g., as discussed in U.S. patent application Ser. No. 18/591,508, which is incorporated by reference herein), etc., or any other devices including sensors positioned near the location of the user.

Additionally, in some examples, the AR eyewear device, and/or a separate device, may include one or more light sources. In such examples, the method 300 may include controlling light sources integrated into the AR eyewear device to provide light to the face of the user (e.g., in a mirror) as the sensor data is being captured, or sending a request to the separate device to cause the separate device (e.g., the user device 104, or another lighting source associated with a mirror in which the user's face is reflected, or another lighting source near the user) to activate a light source to provide light to the face of the user as the sensor data is being captured, e.g., via a network (e.g., network 108), via a short range signal between the separate device and the AR eyewear device, and/or via a wired connection between the separate device and the AR eyewear device. For instance, in some examples, the method 300 may include determining optimized lighting parameters, such as an optimized level, warmth, and/or direction of light to be provided based on the selected makeup look, based on a particular cosmetic product being used, based on a particular step within the process of the selected makeup look, and/or based on ambient lighting conditions in an area where the AR eyewear device is being used, and may control an integrated light source to provide the optimized light level, warmth, and/or direction of light, or send a request to the separate device to provide the optimized light level, warmth, and/or direction of light.

In some examples, the method 300 may include generating an augmented reality (AR) version of the three-dimensional map of the face of the user, and displaying the AR version of the three-dimensional map of the face of the user via a user interface associated with the AR eyewear device (e.g., the AR interface 112 of the AR eyewear device 102).

Additionally, the method 300 may include identifying (block 306) one or more facial features of the face of the user on the three-dimensional map associated with the face of the user. In some examples, this analysis may include applying a trained machine learning model to the three-dimensional map associated with the face of the user to identify the facial features. For instance, the method 300 may include training a machine learning model using historical three-dimensional maps associated with other faces, and corresponding portions of the three-dimensional maps associated with facial features of the other faces, and, once trained, the machine learning model may be capable of identifying such facial features on three-dimensional maps associated with new faces. That is, the trained machine learning model may be operable to recognize facial geometry associated with particular facial features on the three-dimensional map associated with a face. Certain facial geometry on a particular location of the face may correspond to the eyes of the face, while other facial geometry at another location of the face may correspond to the lips of the face, etc.

Moreover, in some examples, the method 300 may include generating a preview of the makeup look selected by the user as applied to facial features of the face of the user on the three-dimensional map associated with the face of the user. For instance, the method 300 may include generating an AR preview of the makeup look selected by the user as applied to facial features of the face of the user on the three-dimensional map associated with the face of the user. Furthermore, the method 300 may include generating an AR preview of the steps of the application process of the makeup look selected by the user to the facial features of the face of the user. For instance, the AR preview of the steps of the application process may include images associated with each step of the application process, and/or videos associated with each step of the application process. The method 300 may further include displaying the AR preview of the selected makeup look, and/or the AR preview of the steps of the application process for the selected makeup look, as an overlay over the actual face of the user, as reflected in a mirror viewed by the user through the AR eyewear device 102.

Furthermore, the method 300 may include controlling (block 308) an augmented reality interface (e.g., the AR interface 112 of the AR eyewear device 102) to provide AR guidance associated with applying one or more cosmetic products to the facial features of the user in order to achieve the makeup look selected by the user, i.e., by instructing the user to apply particular cosmetic products to particular areas of the identified facial features of the face of the user. Providing the AR guidance may include generating an AR overlay superimposed upon the face of the user (e.g., as reflected in a mirror). For instance, the AR overlay may include tracing lines, arrows, and/or other appropriate indicators that a user may follow using an applicator to apply a particular cosmetic product. As one example, the AR overlay may include tracing lines, arrows, and/or other appropriate indicators superimposed upon a user's nose and/or cheeks indicating areas in which contouring products, such as bronzer, blush, highlighter, etc., may be applied to achieve a contoured look selected by the user. As another example, the AR overlay may include tracing lines, arrows, and/or other appropriate indicators superimposed upon a user's lips, indicating areas in which lip products, such as lip liner, lipstick, lip gloss, etc., may be applied in order to achieve a pout lip look selected by the user.

Additionally, in some examples, providing the AR guidance may include magnifying one or more portions of the face of the user, such that the user can view magnified versions of one or more facial features, e.g., in order to apply cosmetic products with greater precision, to notice areas of concern, etc. For example, in association with AR guidance for a step of applying a lip product, the AR guidance may include a magnified version of the user's lips, which the user can view in real time as he or she applies a cosmetic product (e.g., a lip liner product, a lip stain product, a lipstick product, a lip gloss product, etc.) to his or her lips. Similarly, in some examples, providing the AR guidance may include enhancing a level of contrast of one or more portions of the face of the user, so that the user can view higher-contrast versions of one or more facial features, e.g., in order to apply cosmetic products with greater precision, etc. For instance, in association with AR guidance for a step of applying a contouring product, the AR guidance may include a high contrast version of the user's cheekbones, which the user can view in real time as he or she applies a cosmetic product (e.g., a contouring product such as bronzer, blush, highlighter, etc.) to enhance the natural contours of the user's cheekbones. Increasing and/or enhancing the level of contrast of various areas of the user's face may allow users with vision impairments, such as color blindness, to more accurately apply cosmetic products to the user's face.

For instance, the method 300 may include controlling the AR interface to adjust and/or modify the guidance in real-time as the user begins to attempt to take steps to apply the one or more cosmetic products to the face of the user. For example, the method 300 may include analyzing the real-time sensor data to determine that the user has completed a first step of guidance for a particular cosmetic product routine (e.g., based on analyzing the facial features of the user to determine that a particular cosmetic product has been applied, and/or based on analyzing images or video captured as the user applies a particular product to determine that the user has moved an applicator to the user's face in a manner consistent with applying a particular cosmetic product). The method 300 may include providing guidance associated with a second step of the particular cosmetic routine based on determining that the user has completed the first step, and so on until all of the steps are complete. As another example, the method 300 may include modifying one or more subsequent steps based on analyzing the sensor data to determine that the user made a mistake, added a step, skipped a step, and/or otherwise altered the generated guidance for the particular cosmetic product routine.

In some examples, for instance, the AR guidance may be provided when the user has moved an applicator outside of a range associated with the makeup look selected by the user, such that the user may be alerted to move the applicator within the range associated with the selected makeup look. For instance, one type of AR guidance (and/or the absence of AR guidance) may be provided when the user, using an eyeliner applicator, draws a straight line across a user's eyelid for a cat eye look, and another type of AR guidance (and/or the presence of AR guidance) may be provided when the user begins to draw a crooked line or otherwise veer from an initial straight line using the applicator. As another example, a first type of AR guidance may be provided when the user holds a mascara wand applicator too close to the eye to apply mascara, a second type of AR guidance (or the same type of AR guidance as the first type of AR guidance) may be provided when the user holds the mascara wand applicator too far from the eye to apply mascara, and a third type of AR guidance (or the absence of AR guidance) may be provided when the user holds the mascara wand applicator at an appropriate and/or correct distance (and/or holds the mascara wand applicator within a range of appropriate and/or correct distances) from the eye to apply mascara.

The method 300 may further include, in some examples, capturing sensor data associated with particular cosmetic products and/or their packaging (e.g., in addition to capturing sensor data associated with the face of the user). For instance, the method 300 may include capturing data associated with packaging of various cosmetic products, and analyzing the captured data associated with the packaging of the various cosmetic products to identify respective cosmetic products based on their packaging. For instance, in some examples, this analysis may include capturing an image of a cosmetic product package and using object recognition techniques to identify a likely type of cosmetic product and/or likely properties associated with the cosmetic product based on the image. Moreover, in some examples, this analysis may include analyzing an image of the cosmetic product packaging using optical character recognition techniques to identify one or more letters, numbers, words, codes, etc., on the cosmetic product packaging, and accessing a database associated with cosmetic products to match any identified letters, numbers, words, codes, etc., on the cosmetic product packaging with particular cosmetic products and/or particular properties associated therewith. As another example, this analysis may include analyzing an image of the cosmetic product packaging to identify and/or decode a barcode, QR code, etc. For instance, the payload of the barcode, QR code, etc., may include an identification or indication of the cosmetic product and/or properties associated therewith. Moreover, in some examples, the method 300 may include identifying a cosmetic product and/or properties associated therewith based on input provided by a user (e.g., input provided via an integrated user interface of the AR eyewear device, and/or via a user interface of a separate device that is sent to the AR eyewear device). The method 300 may further include adjusting the provided guidance based on particular identified cosmetic products and/or properties associated therewith.

Furthermore, in some examples, the method 300 may include automatically adjusting guidance provided by the AR eyewear device based on one or more of: the cosmetic product(s) being applied by the user, the type of applicator used by the user to apply the one or more cosmetic product(s), the particular makeup look selected, and/or a particular step in the application of the selected makeup look, to guide a user to apply one or more cosmetic products to the face of the user.

Moreover, in some examples, the method 300 may further include analyzing the sensor data in real-time to identify blemishes of the skin of the user, and automatically guidance, based on identified blemishes, i.e., beyond the initial parameters of the selected makeup look. For instance, the method 300 may include adjusting guidance regarding an amount of a particular cosmetic product, e.g., to guide a user to add more foundation or concealer to an area of the user's face including a blemish in order to cover the blemish with the cosmetic product. Furthermore, in some examples, the method 300 may include analyzing the sensor data in real-time to determine whether the blemish is sufficiently covered based on an initial application of the cosmetic product, and may include automatically adjusting guidance to guide a user to add additional cosmetic product as needed until the blemish is sufficiently covered.

Additionally, in some examples, the method 300 may further include analyzing the sensor data in real-time to identify skin reactions of the skin of the user, and automatically generating alerts or notifications based on any identified skin reactions. For instance, the method 300 may include presenting such generated alerts via an integrated user interface of the AR eyewear device, and/or sending such generated alerts to a separate device to be displayed via a user interface of the separate device.

Furthermore, in some examples, the method 300 may further include analyzing the sensor data in real-time to identify properties of the skin of the user, properties of the environment of the user, and/or properties of the one or more cosmetic products being applied, and automatically adjusting the guidance based on one or more of: a skin type associated with the user, a skin health condition associated with the user, a hydration level of the skin of the user, a skin tone associated with the user, current temperature conditions, current humidity conditions, current precipitation conditions, current lighting conditions, a current time of day, and/or one or more properties associated with the one or more cosmetic products being applied. In some examples, this analysis may include applying a trained machine learning model to the sensor data to identify the properties of the skin of the user, the properties of the environment of the user, and/or the properties of the one or more cosmetic products being applied. For instance, the method 300 may include training a machine learning model using historical sensor data associated with skin properties, environmental properties, cosmetic product properties, etc., and, once trained, the machine learning model may be capable of identifying such properties based on new sensor data.

Additionally, in some examples, the method 300 may further include controlling (e.g., using a controller 118) one or more transparent component(s) (e.g., component(s) 114, such as lenses) of the AR eyewear device in order to lift, flip, turn, or otherwise move the transparent component(s) of the AR eyewear device away from one or both eyes of the user (e.g., using one or more actuators). In some examples, the method 300 may include controlling the one or more transparent component(s) to move the transparent component(s) away one or both eyes of the user at times in response to user input provided via an AR interface of the AR eyewear device, or via a user interface of a user device (e.g., in response to receiving input from the user indicating the selection of an option to move one or more of the transparent component(s) of the AR eyewear device). In some examples, the method 300 may include automatically controlling the one or more transparent component(s) to move the transparent component(s) away one or both eyes of the user at times in response to generating guidance (or reaching a particular step in a series of guidance steps) for applying a cosmetic product to one or both eyes of the user.

For instance, in one example, the transparent component(s) may be positioned over the eyes of the user as the AR guidance instructs the user to apply a lip product, a cheek product, etc., but when the AR guidance instructs the user to apply an eye product, the AR eyewear device may automatically adjust one or more of the transparent component(s) so that the user can access his or her eye(s) to apply the eye product. In some examples, after the AR eyewear device provides AR guidance including instructions to apply an eye product, the AR eyewear device may automatically physically adjust both of the transparent components, from a first position over the user's eyes to a second position away from the user's eyes, so that the user can access both eyes to apply the cosmetic product. Then, when the user finishes applying the cosmetic product to both eyes, the AR eyewear device may automatically physically adjust both transparent components from the second position away from the user's eyes back to the first position over the user's eyes.

Moreover, in some examples, the AR eyewear device may provide the AR guidance through the FOV of a first transparent component in a first position over a first eye of the user, instructing the user to apply a cosmetic product to a second eye of the user, and may automatically physically adjust a second transparent component from a first position over the second eye of the user to a second position away from the second eye of the user so that the user can access the second eye of the user to apply the cosmetic product to the second eye. Then, when the step of applying the cosmetic product to the second eye of the user is complete, the AR eyewear device may automatically physically adjust the second transparent component from the second position away from the second eye of the user to the first position over the second eye of the user, and may provide AR guidance via the second transparent component instructing the user to apply a cosmetic product to the first eye, and may automatically adjust the first AR component from the first position over the first eye of the user to the second position away from the first eye of the user so that the user can access the first eye of the user to apply the cosmetic product to the first eye. Then, when the step of applying the cosmetic product to the first eye of the user is complete, the AR eyewear device may automatically physically adjust the first transparent component from the second position away from the first eye of the user to the first position over the first eye of the user.

In some examples, the method 300 may further include receiving feedback associated with the makeup look from the user (e.g., via a user interface) subsequent to the application of the one or more cosmetic products to the face of the user, and storing the feedback associated with the makeup look. For instance, the method 300 may update one or more aspects of the makeup look in future applications based on feedback provided by the user.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for an augmented reality (AR) eyewear device, and/or systems, methods, and/or techniques associated therewith. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### Aspects

1. An augmented reality (AR) eyewear device, comprising: an eyewear frame configured to be worn by a user, the eyewear frame having one or more transparent components associated with eyes of a user; one or more AR interfaces configured to superimpose one or more of text or images upon a field of view (FOV) of the one or more transparent components; one or more sensors configured to capture real-time data associated with a face of a user; one or more processors; and one or more non-transitory computer-readable memories storing instructions that, when executed by the one or more processors, cause the one or more processors to: receive an indication of a makeup look selected by the user; analyze the real-time data associated with the face of the user in order to generate a three-dimensional map associated with the face of the user; identify one or more facial features of the face of the user on the three-dimensional map associated with the face of the user; and provide, via the one or more AR interfaces, guidance associated with applying one or more cosmetic products to the one or more facial features of the user in order to achieve the makeup look selected by the user.
2. The AR eyewear device of aspect 1, wherein the one or more sensors include one or more of a camera or a depth sensor.
3. The AR eyewear device of any one of aspects 1 or 2, wherein providing the guidance includes magnifying one or more portions of the face of the user within the FOV of the one or more transparent components.
4. The AR eyewear device of any one of aspects 1-3, wherein providing the guidance adjusting contrast of one or more portions of the face of the user, within the FOV of the one or more transparent components.
5. The AR eyewear device of any one of aspects 1-4, wherein the guidance includes guidance for applying the one or more cosmetic products to an eye of the user, and wherein the AR eyewear device further comprises one or more actuators configured to adjust the one or more transparent components away from the eye of the user while the guidance for applying the one or more cosmetic products to the eye of the user is provided.
6. The AR eyewear device of any one of aspects 1-5, wherein the guidance includes a plurality of steps associated with applying one or more cosmetic products to the one or more facial features of the user in order to achieve the makeup look selected by the user, and wherein the instructions, when executed by the one or more processors, further cause the one or more processors to: provide, via the one or more AR interfaces, guidance associated with a first step of the plurality of steps; analyze the real-time data associated with the face of the user in order to determine that the first step of the plurality of steps has been completed by the user; and based on determining that the first step of the plurality of steps has been completed by the user, provide, via the one or more AR interfaces, guidance associated with a second step of the plurality of steps.
7. The AR eyewear device of any one of aspects 1-6, wherein the guidance includes tracing lines or arrows associated with applying one or more cosmetic products to the one or more facial features of the user in order to achieve the makeup look selected by the user.
8. The AR eyewear device of any one of aspects 1-7, wherein the AR eyewear device includes an audio component, and wherein providing guidance associated with applying the one or more cosmetic products to the one or more facial features of the user includes providing audio guidance via the audio component.
9. The AR eyewear device of any one of aspects 1-8, further comprising a communication interface configured to communicate with a mobile device, external to the AR eyewear device.
10. The AR eyewear device of aspect 9, wherein the communication interface is a wired communication interface.
11. The AR eyewear device of aspect 9, wherein the communication interface is a wireless communication interface.
12. The AR eyewear device of any one of aspects 1-11, wherein the instructions, when executed by the one or more processors, further cause the one or more processors to generate a three-dimensional preview of the makeup look selected by the user as applied to the three-dimensional map associated with the face of the user, and wherein the one or more AR interfaces are further configured to generate and display an AR version of the three-dimensional preview of the makeup look selected by the user as applied to the three-dimensional map associated with the face of the user, superimposed on the face of the user within the FOV of the one or more transparent components.
13. The AR eyewear device of aspect 12, wherein the three-dimensional preview of the makeup look selected by the user includes a three-dimensional preview of an application process of the makeup look selected by the user.
14. The AR eyewear device of any one of aspects 1-13, further comprising a light source configured to provide light to the face of the user.
15. The AR eyewear device of aspect 14, wherein the instructions, when executed by the one or more processors, further cause the one or more processors to control the light source to provide particular lighting conditions while the one or more cosmetic products are applied to the one or more facial features of the user.
16. The AR eyewear device of any one of aspects 1-15, wherein the instructions, when executed by the one or more processors, further cause the one or more processors to analyze the real-time data in order to identify one or more cosmetic products within the FOV of the one or more transparent components.
17. The AR eyewear device of aspect 16, wherein the guidance further includes indications of the one or more identified cosmetic products within the FOV of the one or more transparent components.
18. The AR eyewear device of aspect 17, wherein the indications of the one or more identified cosmetic products are superimposed upon the respective one or more identified cosmetic products within the FOV of the one or more transparent components.
19. A computer-implemented method for operating an augmented reality (AR) eyewear device, the computer-implemented method comprising: receiving, by one or more processors, an indication of a makeup look selected by a user of the AR eyewear device; analyzing, by the one or more processors, real-time data associated with a face of the user captured by one or more sensors of the AR eyewear device in order to generate a three-dimensional map associated with the face of the user; identifying, by the one or more processors, one or more facial features of the face of the user on the three-dimensional map associated with the face of the user; and causing, by the one or more processors, one or more AR interfaces of the AR eyewear device to superimpose, upon a field of view (FOV) of one or more transparent components of the AR eyewear device associated with one or more eyes of the user, guidance associated with applying one or more cosmetic products to the one or more facial features of the user in order to achieve the makeup look selected by the user.
20. A non-transitory computer-readable medium storing instructions for operating an augmented reality (AR) eyewear device that, when executed by one or more processors, cause the one or more processors to perform a method comprising: receiving an indication of a makeup look selected by a user of the AR eyewear device; analyzing real-time data associated with a face of the user captured by one or more sensors of the AR eyewear device in order to generate a three-dimensional map associated with the face of the user; identifying one or more facial features of the face of the user on the three-dimensional map associated with the face of the user; and causing one or more AR interfaces of the AR eyewear device to superimpose, upon a field of view (FOV) of one or more transparent components of the AR eyewear device associated with one or more eyes of the user, guidance associated with applying one or more cosmetic products to the one or more facial features of the user in order to achieve the makeup look selected by the user.

What is claimed is:

1. An augmented reality (AR) eyewear device, comprising:
an eyewear frame configured to be worn by a user, the eyewear frame having one or more transparent components associated with eyes of a user;
one or more AR interfaces configured to superimpose one or more of text or images upon a field of view (FOV) of the one or more transparent components;
one or more sensors configured to capture real-time data associated with a face of a user;
one or more processors; and
one or more non-transitory computer-readable memories storing instructions that, when executed by the one or more processors, cause the one or more processors to:
receive an indication of a makeup look selected by the user;
analyze the real-time data associated with the face of the user in order to generate a three-dimensional map associated with the face of the user;
identify one or more facial features of the face of the user on the three-dimensional map associated with the face of the user; and
provide, via the one or more AR interfaces, guidance associated with applying one or more cosmetic products to the one or more facial features of the user in order to achieve the makeup look selected by the user.

2. The AR eyewear device of claim 1, wherein the one or more sensors include one or more of a camera or a depth sensor.

3. The AR eyewear device of claim 1, wherein providing the guidance includes magnifying one or more portions of the face of the user within the FOV of the one or more transparent components.

4. The AR eyewear device of claim 1, wherein providing the guidance adjusting contrast of one or more portions of the face of the user, within the FOV of the one or more transparent components.

5. The AR eyewear device of claim 1, wherein the guidance includes guidance for applying the one or more cosmetic products to an eye of the user, and wherein the AR eyewear device further comprises one or more actuators configured to adjust the one or more transparent components away from the eye of the user while the guidance for applying the one or more cosmetic products to the eye of the user is provided.

6. The AR eyewear device of claim 1, wherein the guidance includes a plurality of steps associated with applying one or more cosmetic products to the one or more facial features of the user in order to achieve the makeup look selected by the user, and wherein the instructions, when executed by the one or more processors, further cause the one or more processors to:
provide, via the one or more AR interfaces, guidance associated with a first step of the plurality of steps;
analyze the real-time data associated with the face of the user in order to determine that the first step of the plurality of steps has been completed by the user; and
based on determining that the first step of the plurality of steps has been completed by the user, provide, via the one or more AR interfaces, guidance associated with a second step of the plurality of steps.

7. The AR eyewear device of claim 1, wherein the guidance includes tracing lines or arrows associated with applying one or more cosmetic products to the one or more facial features of the user in order to achieve the makeup look selected by the user.

8. The AR eyewear device of claim 1, wherein the AR eyewear device includes an audio component, and wherein providing guidance associated with applying the one or more cosmetic products to the one or more facial features of the user includes providing audio guidance via the audio component.

9. The AR eyewear device of claim 1, further comprising a communication interface configured to communicate with a mobile device, external to the AR eyewear device.

10. The AR eyewear device of claim 9, wherein the communication interface is a wired communication interface.

11. The AR eyewear device of claim 9, wherein the communication interface is a wireless communication interface.

12. The AR eyewear device of claim 1, wherein the instructions, when executed by the one or more processors, further cause the one or more processors to generate a three-dimensional preview of the makeup look selected by the user as applied to the three-dimensional map associated with the face of the user, and wherein the one or more AR interfaces are further configured to generate and display an AR version of the three-dimensional preview of the makeup look selected by the user as applied to the three-dimensional map associated with the face of the user, superimposed on the face of the user within the FOV of the one or more transparent components.

13. The AR eyewear device of claim 12, wherein the three-dimensional preview of the makeup look selected by the user includes a three-dimensional preview of an application process of the makeup look selected by the user.

14. The AR eyewear device of claim 1, further comprising a light source configured to provide light to the face of the user.

15. The AR eyewear device of claim 14, wherein the instructions, when executed by the one or more processors, further cause the one or more processors to control the light source to provide particular lighting conditions while the one or more cosmetic products are applied to the one or more facial features of the user.

16. The AR eyewear device of claim 1, wherein the instructions, when executed by the one or more processors, further cause the one or more processors to analyze the real-time data in order to identify one or more cosmetic products within the FOV of the one or more transparent components.

17. The AR eyewear device of claim 16, wherein the guidance further includes indications of the one or more identified cosmetic products within the FOV of the one or more transparent components.

18. The AR eyewear device of claim 17, wherein the indications of the one or more identified cosmetic products are superimposed upon the respective one or more identified cosmetic products within the FOV of the one or more transparent components.

19. A computer-implemented method for operating an augmented reality (AR) eyewear device, the computer-implemented method comprising:
receiving, by one or more processors, an indication of a makeup look selected by a user of the AR eyewear device;
analyzing, by the one or more processors, real-time data associated with a face of the user captured by one or more sensors of the AR eyewear device in order to generate a three-dimensional map associated with the face of the user;
identifying, by the one or more processors, one or more facial features of the face of the user on the three-dimensional map associated with the face of the user; and
causing, by the one or more processors, one or more AR interfaces of the AR eyewear device to superimpose, upon a field of view (FOV) of one or more transparent components of the AR eyewear device associated with one or more eyes of the user, guidance associated with applying one or more cosmetic products to the one or more facial features of the user in order to achieve the makeup look selected by the user.

20. A non-transitory computer-readable medium storing instructions for operating an augmented reality (AR) eyewear device that, when executed by one or more processors, cause the one or more processors to perform a method comprising:
receiving an indication of a makeup look selected by a user of the AR eyewear device;
analyzing real-time data associated with a face of the user captured by one or more sensors of the AR eyewear device in order to generate a three-dimensional map associated with the face of the user;
identifying one or more facial features of the face of the user on the three-dimensional map associated with the face of the user; and
causing one or more AR interfaces of the AR eyewear device to superimpose, upon a field of view (FOV) of one or more transparent components of the AR eyewear device associated with one or more eyes of the user, guidance associated with applying one or more cosmetic products to the one or more facial features of the user in order to achieve the makeup look selected by the user.
